(19) United States
(12) Patent Application Publication
(10) Pub. No.: US 2019/0017452 A1
(43) Pub. Date: Jan. 17, 2019

(54) AIR PATH CONTROL FOR ENGINE ASSEMBLY WITH WASTE-GATED TURBINE

(71) Applicant: GM GLOBAL TECHNOLOGY OPERATIONS LLC, Detroit, MI (US)

(72) Inventors: Yue-Yun Wang, Troy, MI (US); Ruixing Long, Windsor (CA)

(73) Assignee: GM GLOBAL TECHNOLOGY OPERATIONS LLC, Detroit, MI (US)

(21) Appl. No.: 15/647,980

(22) Filed: Jul. 12, 2017

(51) Int. Cl. F02D 41/00; F02D 41/26; F02D 9/02; F02B 37/18

(52) U.S. Cl. CPC F02D 41/0007; F02D 41/26; F02D 2200/02; F02B 37/183; F02D 9/02

(57) ABSTRACT

An engine assembly includes an engine, a compressor, a turbine and a waste gate valve. A controller has a processor and a tangible, non-transitory memory on which is recorded instructions for executing a method of air path control based on an air path model. The controller is configured to determine a turbine power (Pₜ) as a function of a first factor (x₁) and a second factor (x₂). A compressor power (P_{c}) is determined as a function of a third factor (y₁) and a fourth factor (y₂). The controller is configured to control at least one of an intake throttle pressure (pₜₕ) and an intake manifold pressure (pᵢ) by varying at least one of the first through fourth factors (x₁, x₂, y₁, y₂). The engine output is controlled based on at least one of the intake throttle and manifold pressures.

### INTRODUCTION

The disclosure relates generally to control of an engine assembly, and more particularly, to air path control for an engine assembly having a waste-gated turbine. A turbine utilizes pressure in an exhaust system of the engine to drive a compressor to provide boost air to the engine. The boost air increases the flow of air to the engine, compared to a naturally aspirated intake system, and therefore increases the output of the engine. Modeling compressor and turbine efficiency is challenging due to its non-linearity, making model-based control of boost pressure a challenging endeavor.

### SUMMARY

An engine assembly includes an engine, an intake air throttle and a turbine operatively connected to one another, with the turbine being operable at a turbine speed (Nₜ). A compressor is operatively connected to the engine. A waste gate valve is operatively connected to the turbine and configured to have a variable waste gate position (WGₚₒₛ). A controller is operatively connected to the turbine and the intake air throttle. The controller has a processor and a tangible, non-transitory memory on which is recorded instructions for executing a method of air path control. The method relies on a physics-based air path model that may be implemented in a variety of forms. A variety of model-based air path control strategies may be derived based on this air path model, including but not limited to, feedforward combined with feedback control, feedback linearization and model predictive control. The method avoids the modeling of turbine and compressor efficiencies and may be implemented into a vehicle control unit as an embedded system controller with minimal calibration efforts.

Execution of the instructions by the processor caused the controller to determine a turbine power (Pₜ) of the turbine as at least one of a look-up factor and a polynomial function of a first factor (x₁) and a second factor (x₂). The controller is configured to determine a compressor power (P_{c}) of the compressor as at least one of a look-up factor and a polynomial function of a third factor (y₁) and a fourth factor (y₂). The controller is configured to control at least one of an intake throttle pressure (pₜₕ) and an intake manifold pressure (pᵢ) by varying at least one of the first, second, third and fourth factors (x₁, x₂, y₁, y₂). The torque output of the engine is controlled based in part on at least one of the intake throttle pressure (pₜₕ) and the intake manifold pressure (pᵢ).

Determining the turbine power (Pₜ) includes determining a turbine power transfer rate (R̅ₜ) as a polynomial function of the first factor (x₁), the second factor (x₂) and a plurality of constants (a) such that (Rₜ=a₀+a₁x₁+a₂x₂+a₃x₁²+a₄x₂²+a₅x₁·x₂+ . . . ). The turbine power (Pₜ) is based in part on a turbine outlet pressure (pₜₒ), an exhaust temperature (Tₓ) and the turbine power transfer rate (Rₜ). The first factor (x₁) and the second factor (x₂) are represented by a modified total exhaust flow

$$( {x}_{1} = \frac{{W}_{ex} \sqrt{{T}_{x}}}{{p}_{to}} )$$

and the waste gate position (x₂=WGₚₒₛ), respectively.

Determining the compressor power (P_{c}) includes determining a compressor power transfer rate (R_{c}) as a polynomial function of the third factor (y₁), the fourth factor (y₂) and a plurality of constants (b). The compressor power (P_{c}) is based in part on an enthalpy factor (h_{c}) and the compressor power transfer rate (R_{c}), defined as: (R_{c}=b₀+b₁y₁+b₂y₂+b₃y₁²+b₄y₂²+b₅y₁·y₂+ . . . ). The third factor (y₁) and the fourth factor (y₂) are represented by the compressor pressure ratio (y₁=p_{rc}) and a modified compressor flow

$$( {y}_{2} = \frac{{W}_{C} \sqrt{{T}_{a}}}{{p}_{a}} ) ,$$

respectively.

The intake throttle pressure (pₜₕ) may be based in part on a compressor flow (W_{c}), a compressor outlet temperature (T_{co}), an intake air throttle flow (Wₜₕ), a charge-air-cooler outlet temperature (T_{CACO}) and a predefined constant

$$( \frac{γ R}{{V}_{cac}} ) .$$

The intake manifold pressure (pᵢ) may be based in part on an intake air throttle flow (Wₜₕ), a charge-air-cooler outlet temperature (T_{CACO}), a cylinder inlet flow (W_{cyl}), an engine speed (Nₑ), an intake manifold temperature (Tᵢₘ), and a predefined constant

$$( \frac{γ R}{{V}_{im}} ) .$$

The controller is configured to determine one or more control parameters based in part on an energy balance relationship between the turbine power (Pₜ) the compressor power (P_{c}). The intake throttle pressure (pₜₕ) and the intake manifold pressure (pᵢ) are based at least partially on the control parameters. The energy-balance relationship may be based on a turbine speed (Nₜ), a turbine inertia (J) and a predefined constant (k). In a first embodiment, a second embodiment and a third embodiment, the energy-balance relationship is defined as:

$$\frac{1}{2} J \frac{{dN}_{t}^{2}}{dt} = {kN}_{t}^{2} - {P}_{c} + {P}_{t} .$$

In the first embodiment, the one or more control parameters include the turbine speed (Nₜ) and a modified compressor flow

$$( \frac{{W}_{C} \sqrt{{T}_{a}}}{{p}_{a}} )$$

based on an ambient temperature (Tₐ) and an ambient pressure (pₐ).

In the second embodiment, the one or more control parameters include the turbine speed (Nₜ), a compressor pressure ratio (p_{rc}) and a compressor flow rate (dW_{c}/dt). The compressor flow rate (dW_{c}/dt) is based in part on the compressor outlet pressure (p_{co}), an intake manifold section area (Aᵢₘ) and an intake manifold length (Lᵢₘ) such that

$$\frac{{dW}_{C}}{dt} = \frac{{A}_{im}}{{L}_{im}} ( {p}_{co} - {p}_{th} ) .$$

In the third embodiment, the one or more control parameters include the turbine speed (Nₜ), a turbine pressure ratio (pᵣₜ) and a turbine flow (W_{c}).

In a fourth embodiment, the one or more control parameters include a modified exhaust flow

$$( \frac{{W}_{ex} \sqrt{{T}_{x}}}{{p}_{to}} ) .$$

In the fourth embodiment, the energy-balance relationship is defined as:

$$\frac{{dP}_{c}}{dt} = - {gP}_{c} + {P}_{t} ,$$

where g is a predefined constant.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary view of an engine assembly having a controller;

FIG. 2 is a flowchart for a method executable by the controller of FIG. 1; and

FIG. 3 is an example control structure for optimizing the method of FIG. 2.

### DETAILED DESCRIPTION

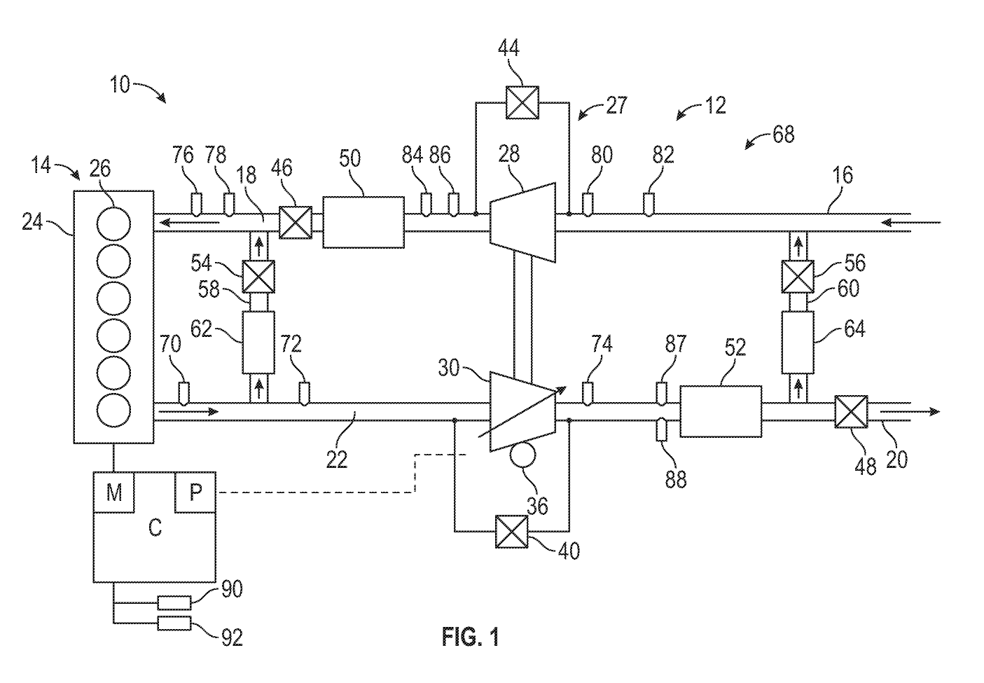

Referring to the drawings, wherein like reference numbers refer to like components, FIG. 1 schematically illustrates a device 10 having an engine assembly 12. The device 10 may be a mobile platform, such as, but not limited to a, standard passenger car, sport utility vehicle, light truck, heavy duty vehicle, ATV, minivan, bus, transit vehicle, bicycle, robot, farm implement, sports-related equipment, boat, plane, train or other transportation device. The device 10 may take many different forms and include multiple and/or alternate components and facilities.

The assembly 12 includes an internal combustion engine 14, referred to herein as engine 14, for combusting an air-fuel mixture in order to generate output torque. The assembly 12 includes an intake manifold 16, which may be configured to receive fresh air from the atmosphere. The engine 14 may combust an air-fuel mixture, producing exhaust gases. The intake manifold 16 is fluidly coupled to the engine 14 and capable of directing air into the engine 14, via an air inlet conduit 18. The assembly 12 includes an exhaust manifold 20 in fluid communication with the engine 14, and capable of receiving and expelling exhaust gases from the engine 14, via an exhaust gas conduit 22. Referring to FIG. 1, the engine 14 includes an engine block 24 having at least one cylinder 26. The engine 14 may be either a spark-ignition engine or a compression-ignition engine, and may be piston-driven.

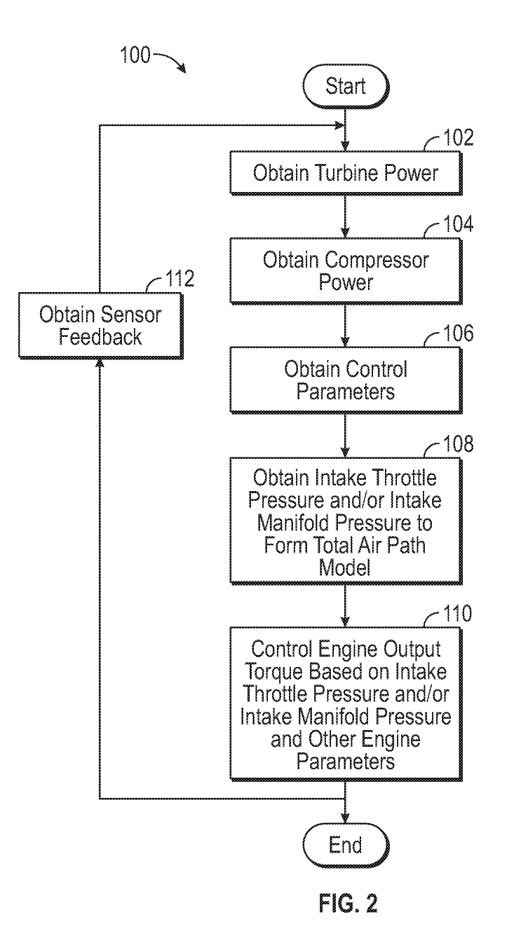

Referring to FIG. 1, the assembly 12 includes a controller C operatively connected to or in electronic communication with the engine 14. Referring to FIG. 1, the controller C includes at least one processor P and at least one memory M (or any non-transitory, tangible computer readable storage medium) on which are recorded instructions for executing method 100, shown in FIG. 2 and described below, for air path control in the assembly 12. The memory M can store controller-executable instruction sets, and the processor P can execute the controller-executable instruction sets stored in the memory M.

Referring to FIG. 1, the assembly 12 includes a compressor 28 configured to be driven by a turbine 30. The compressor 28 is employed to compress the inlet air to increase its density to provide a higher concentration of oxygen in the air fed to the engine 14. Referring to FIG. 1, the turbine 30 may be a fixed geometry turbine (FGT), with a wastegate valve 40 having a wastegate geometry sensor 36 to measure wastegate position, for providing real-time information concerning the geometry of the turbine 30 to the controller C.

Referring to FIG. 1, the wastegate valve 40 is configured to open when the intake throttle pressure (also referred to as boost pressure) is sufficiently high. The boost pressure may be modulated by continuously modulating the opening of wastegate valve 40. A compressor bypass valve 44 is configured to allow bypass of the compressor 28. Referring to FIG. 1, the assembly 12 includes an intake throttle valve 46 fluidly connected to the air inlet conduit 18 and an exhaust throttle valve 48 fluidly connected to the exhaust gas conduit 22. The exhaust throttle valve 48 may be generally open and may be closed to raise the exhaust pressure (pₓ). A charged air cooler (CAC) 50 is employed to dissipate some of the heat resulting from compression of the inlet air. An after treatment system 52 may be positioned between the exhaust manifold 20 and a point on the exhaust gas conduit 22 at which exhaust gases are released to the atmosphere. The after treatment system 52 may include oxidation and NOx reduction catalysts and a particulate filter.

The assembly 12 may include an exhaust gas recirculation (EGR) system with multiple routes of recirculating exhaust gas. Referring to FIG. 1, a high pressure exhaust gas recirculation valve 54 and a low pressure exhaust gas recirculation valve 56 are located in respective first and second conduits 58, 60 provided between the air inlet conduit 18 and the exhaust gas conduit 22. A first cooling unit 62 and a second cooling unit 64 may be operatively connected to the high pressure EGR valve 54 and the low pressure EGR valve 56, respectively. The first and second cooling units 62, 64 are employed to reduce the temperature of the re-circulated exhaust gases prior to mixing with air being admitted through the intake manifold 16.

Referring to FIG. 1, the controller C is configured to receive sensor feedback from one or more sensors 68. In the embodiment shown, the sensors 68 include an exhaust temperature sensor 70, an exhaust pressure sensor (or a virtual sensor) 72, intake manifold pressure sensor 76, intake manifold temperature sensor 78, compressor inlet temperature sensor 80, compressor outlet pressure sensor 86, compressor outlet temperature sensor (or virtual sensor) 84, a combination sensor of mass airflow rate and compressor inlet pressure 82, post-turbine pressure sensor 87 and post-turbine temperature sensor 88. The controller C is programmed to receive a torque request from an operator input or an auto start condition or other source monitored by the controller C. The controller C may be configured to receive input signals from an operator, such as through an accelerator pedal 90 and brake pedal 92, to determine the torque request.

Referring now to FIG. 2, a flowchart of the method 100 stored on and executable by the controller C of FIG. 1 is shown. The method 100 is also illustrated with respect to four embodiments. The controller C of FIG. 1 is specifically programmed to execute the steps of the method 100. The method 100 need not be applied in the specific order recited herein. Furthermore, it is to be understood that some steps may be eliminated. The various parameters listed below may be obtained via “virtual sensing”, such as for example, modeling based on other measurements or calibration under test conditions. For example, the intake temperature may be virtually sensed based on a measurement of ambient temperature and other engine measurements.

Referring to FIG. 2, method 100 may begin with block 102, where the controller C is programmed or configured to determine a turbine power (Pₜ) of the turbine as a function of a first factor (x₁) and a second factor (x₂), the first factor being the waste gate position (x₁=WGₚₒₛ). Determining the turbine power (Pₜ) includes determining a turbine power transfer rate (Rₜ) as a nonlinear function or a polynomial function of a first factor (x₁), a second factor (x₂) and a plurality of constants (a) such that:

Rₜ=a₀+a₁x₁+a₂x₂+a₃x₁²+a₄x₂²+a₅x₁·x₂+ . . .

The turbine power (Pₜ) is based in part on a turbine outlet pressure (pₜₒ), an exhaust temperature (Tₓ) and the turbine power transfer rate (Rₜ). The first factor (x₁) and the second factor (x₂) are represented by a modified total exhaust flow

$$( {x}_{1} = \frac{{W}_{ex} \sqrt{{T}_{x}}}{{p}_{to}} )$$

and the waste gate position (x₂=WGₚₒₛ), respectively. The plurality of constants (aᵢ) may be obtained by calibration, for example, by obtaining turbine power (Pₜ) readings over a range of turbine speeds in a test cell. The turbine power transfer rate (R_{c}) may be stored as a look-up table of the first factor (x₁) and the second factor (x₂).

In block 104 of FIG. 2, the controller C is programmed to determine a compressor power (P_{c}) of the compressor as a function of a third factor (y₁) and a fourth factor (y₂). Determining the compressor power (P_{c}) includes determining a compressor power transfer rate (R_{c}) as a nonlinear function or a polynomial function of a third factor (y₁), a fourth factor (y₂) and a plurality of constants (bᵢ) such that:

R_{c}=b₀+b₁y₁+b₂y₂+b₃y₁²+b₄y₂²+b₅y₁·y₂+ . . .

The compressor power (P_{c}h_{c}*R_{c}) is based in part on an enthalpy factor (h_{c}) and the compressor power transfer rate (R_{c}). The third factor (y₁) and the fourth factor (y₂) are represented by the compressor pressure ratio (y₁+p_{rc}) and a modified compressor flow

$$( {y}_{2} = \frac{{W}_{C} \sqrt{{T}_{a}}}{{p}_{a}} ) ,$$

respectively. The plurality of constants (bᵢ) may be obtained by calibration, by obtaining compressor power (P_{c}) readings over a range of turbine speeds in a test cell. The compressor power (P_{c}) may be stored as a look-up table of the third factor (y₁) and the fourth factor (y₂).

In block 106 of FIG. 2, the controller C is programmed to determine one or more control parameter based in part on the turbine power (Pₜ), the compressor power (P_{c}) and an energy balance relationship, where the intake throttle pressure (pₜₕ) and the intake manifold pressure (pᵢ) are based at least partially on the one or more control parameters. Per block 106, in each of a first, second and third embodiments, the energy-balance relationship is defined as:

$$\frac{1}{2} J \frac{{dN}_{t}^{2}}{dt} = {kN}_{t}^{2} - {P}_{c} + {P}_{t}$$

Here J is turbine inertia and k is a predefined constant. In the first embodiment, the one or more control parameters include the turbine speed (Nₜ) and a modified compressor flow

$$( \frac{{W}_{C} \sqrt{{T}_{a}}}{{p}_{a}} )$$

that varies based on an ambient temperature (Tₐ) and an ambient pressure (pₐ).

In the second embodiment, the one or more control parameters include the turbine speed (Nₜ), a compressor pressure ratio (p_{rc}) (as a function of the following parameters such that:

$${p}_{rc} = f ( \frac{{W}_{C} \sqrt{{T}_{a}}}{{p}_{a}} , \frac{{N}_{t}}{\sqrt{{T}_{a}}} ) )$$

and a compressor flow rate (dW_{c}/dt). The compressor flow rate (dW_{c}/dt) is based in part on the compressor outlet pressure (p_{co}), an intake manifold section area (Aᵢₘ) and an intake manifold length (Lᵢₘ) such that:

$$\frac{{dW}_{C}}{dt} = \frac{{A}_{im}}{{L}_{im}} ( {p}_{co} - {p}_{th} ) .$$

In the third embodiment, the one or more control parameters include the turbine speed (Nₜ), a turbine pressure ratio (pᵣₜ) and an intake air throttle flow (Wₜₕ). The compressor pressure ratio (p_{rc}) and the turbine flow (W_{c}) may be expressed as:

$${p}_{rt} = f ( \frac{{W}_{ex} \sqrt{{T}_{x}}}{{p}_{to}} , {WG}_{pos} ) , {W}_{t} = \frac{{p}_{to}}{\sqrt{{T}_{x}}} f ( {p}_{rt} )$$

In a fourth embodiment, the control parameters include a modified exhaust flow

$$( \frac{{W}_{ex} \sqrt{{T}_{x}}}{{p}_{to}} ) .$$

In the fourth embodiment, the energy-balance relationship is defined as:

$$\frac{{dP}_{c}}{dt} = - {gP}_{c} + {p}_{to} \sqrt{{T}_{x}} {\overline{R}}_{t} ( \frac{{W}_{ex} \sqrt{{T}_{x}}}{{p}_{to}} , {WG}_{pos} ) = - {gP}_{c} + {p}_{to} \sqrt{{T}_{x}} {\overline{R}}_{t} ( {p}_{rt} ) = - {gP}_{c} + {P}_{t} ,$$

where g is a predefined constant. The modified compressor flow may be represented by a calibrated function as follows:

$$\frac{{W}_{C} \sqrt{{T}_{a}}}{{p}_{a}} = f ( {p}_{rc} , \frac{{P}_{c}}{{p}_{a} \sqrt{{T}_{a}}} ) .$$

The method 100 proceeds to block 108 of FIG. 2, where the controller C is programmed to obtain at least one of an intake throttle pressure (pₜₕ) (also known as boost pressure) and an intake manifold pressure (pᵢ) to form the total air path model. In block 108, the controller C is programmed to control at least one of the intake throttle pressure (pₜₕ) and the intake manifold pressure (pᵢ) by varying at least one of the first, second, third and fourth factors (x₁, x₂, y₁, y₂). The intake throttle pressure (pₜₕ) may be modeled based in part on a compressor flow (W_{c}), a compressor outlet temperature (T_{co}), an intake air throttle flow (Wₜₕ), a charge-air-cooler outlet temperature (T_{CACO}) and a predefined constant

$$( \frac{γ R}{{V}_{cac}} ) ,$$

which is based on a volume (V_{CAC}) of the compressed air cooler 50 and the universal gas constant (R). A rate of change

$$( \frac{{dp}_{th}}{dt} )$$

of the intake throttle pressure may be modeled as:

$$\frac{{dp}_{th}}{dt} = \frac{γ R}{{V}_{cac}} ( {W}_{C} {T}_{co} - {W}_{th} {T}_{CACO} ) .$$

The intake manifold pressure (pᵢ) may be modeled based in part on an intake air throttle flow (Wₜₕ), a charge-air-cooler outlet temperature (T_{CACO}), a cylinder inlet flow (W_{cyl}), an engine speed (Nₑ), an intake manifold temperature (Tᵢₘ), and a predefined constant

$$( \frac{γ R}{{V}_{im}} ) ,$$

which is based on a volume (Vᵢₘ) of the intake manifold 16 and the universal gas constant (R). The rate of change of intake manifold pressure may be modeled as:

$$\frac{{dp}_{i}}{dt} = \frac{γ R}{{V}_{im}} ( {W}_{th} {T}_{CACO} - {W}_{cyl} ( {N}_{e} ) {T}_{im} )$$

In block 110 of FIG. 2, the controller C is programmed to control an output of the engine torque based in part on at least one of the intake throttle pressure (pₜₕ) and the intake manifold pressure (pᵢ) as well as other engine parameters such as spark timing, intake valve timing and exhaust valve timing. The intake throttle pressure (pₜₕ) and the intake manifold pressure (pᵢ) each affect boost air, which increases the flow of air to the engine 14 and therefore increases the output torque of the engine 14. The output of the engine 14 may be modulated via at least one of the intake throttle pressure (pₜₕ) and the intake manifold pressure (pᵢ) as well as valve timing through air path control. In block 112 of FIG. 2, the controller C is programmed to obtain sensor feedback from the plurality of sensors 68, described above. The controller C may include a closed-loop control unit configured to employ the sensor feedback for the next cycle.

In summary, the method 100 provides model-based air path control using a plurality of air path models. In the first embodiment, the air path model is characterized as:

$$\frac{1}{2} J \frac{{dN}_{t}^{2}}{dt} = {aN}_{t}^{2} + {p}_{to} \sqrt{{T}_{x}} {\overline{R}}_{t} ( \frac{{W}_{ex} \sqrt{{T}_{x}}}{{p}_{to}} , {WG}_{pos} ) - {h}_{c} {R}_{c} ( {p}_{rc} , \frac{{W}_{C} \sqrt{{T}_{a}}}{{p}_{a}} )$$

$$\frac{{W}_{C} \sqrt{{T}_{a}}}{{p}_{a}} = f ( {p}_{rc} , \frac{{N}_{t}}{\sqrt{{T}_{a}}} )$$

$$\frac{{dp}_{th}}{dt} = \frac{γ R}{{V}_{cac}} ( {W}_{C} {T}_{co} - {W}_{th} {T}_{CACO} )$$

$$\frac{{dp}_{i}}{dt} = \frac{γ R}{{V}_{im}} ( {W}_{th} {T}_{CACO} - {W}_{cyl} ( {N}_{e} ) {T}_{im} )$$

An alternative model is presented in the second embodiment:

$$\frac{1}{2} J \frac{{dN}_{t}^{2}}{dt} = {aN}_{t}^{2} + {p}_{to} \sqrt{{T}_{x}} {\overline{R}}_{t} ( \frac{{W}_{ex} \sqrt{{T}_{x}}}{{p}_{to}} , {WG}_{pos} ) - {h}_{c} {R}_{c} ( {p}_{rc} , \frac{{W}_{C} \sqrt{{T}_{a}}}{{p}_{a}} )$$

$${p}_{rc} = f ( \frac{{W}_{C} \sqrt{{T}_{a}}}{{p}_{a}} , \frac{{N}_{t}}{\sqrt{{T}_{a}}} )$$

$$\frac{{dW}_{C}}{dt} = \frac{{A}_{im}}{{L}_{im}} ( {p}_{co} - {p}_{th} )$$

In the third embodiment, the air path model is characterized as:

$$\frac{1}{2} J \frac{{dN}_{t}^{2}}{dt} = {aN}_{t}^{2} + {W}_{t} {c}_{p} {T}_{x} {R}_{t} ( {p}_{rt} ) - {h}_{c} {R}_{c} ( {p}_{rc} , \frac{{W}_{C} \sqrt{{T}_{a}}}{{p}_{a}} ) = {aN}_{t}^{2} + {p}_{to} \sqrt{{T}_{x}} {\overline{R}}_{t} ( {p}_{rt} ) - {h}_{c} {R}_{c} ( {p}_{rc} , \frac{{W}_{C} \sqrt{{T}_{a}}}{{p}_{a}} )$$

$${p}_{rt} = f ( \frac{{W}_{ex} \sqrt{{T}_{x}}}{{p}_{to}} , {WG}_{pos} ) , \\ {W}_{t} = \frac{{p}_{to}}{\sqrt{{T}_{x}}} f ( {p}_{rt} )$$

$${p}_{rc} = f ( \frac{{W}_{C} \sqrt{{T}_{a}}}{{p}_{a}} , \frac{{N}_{t}}{\sqrt{{T}_{a}}} )$$

In the fourth embodiment, the air path model is characterized as:

$$\frac{{dP}_{c}}{dt} = - {aP}_{c} + {p}_{to} \sqrt{{T}_{x}} {\overline{R}}_{t} ( \frac{{W}_{ex} \sqrt{{T}_{x}}}{{p}_{to}} , {WG}_{pos} ) = - {aP}_{c} + {p}_{to} \sqrt{{T}_{x}} {\overline{R}}_{t} ( {p}_{rt} )$$

$$\frac{{W}_{C} \sqrt{{T}_{a}}}{{p}_{a}} = f ( {p}_{rc} , \frac{{P}_{c}}{{p}_{a} \sqrt{{T}_{a}}} )$$

$$\frac{{dp}_{th}}{dt} = \frac{γ R}{V} ( {W}_{C} {T}_{co} - {W}_{th} {T}_{CACO} )$$

$$\frac{{dp}_{i}}{dt} = \frac{γ R}{{V}_{im}} ( {W}_{th} {T}_{CACO} - {W}_{cyl} ( {N}_{e} ) {T}_{im} )$$

These models, along with other model-based air path control units, may be implemented into a vehicle control unit as the part of the embedded system controller with minimal calibration efforts. The method 100 enables the maximization of engine breathing and minimization of pumping loss. The method 100 provides an effective and efficient way to deal with a complex system, maximize boosting capability and reduce fuel consumption, in order to optimize and control the assembly 12.

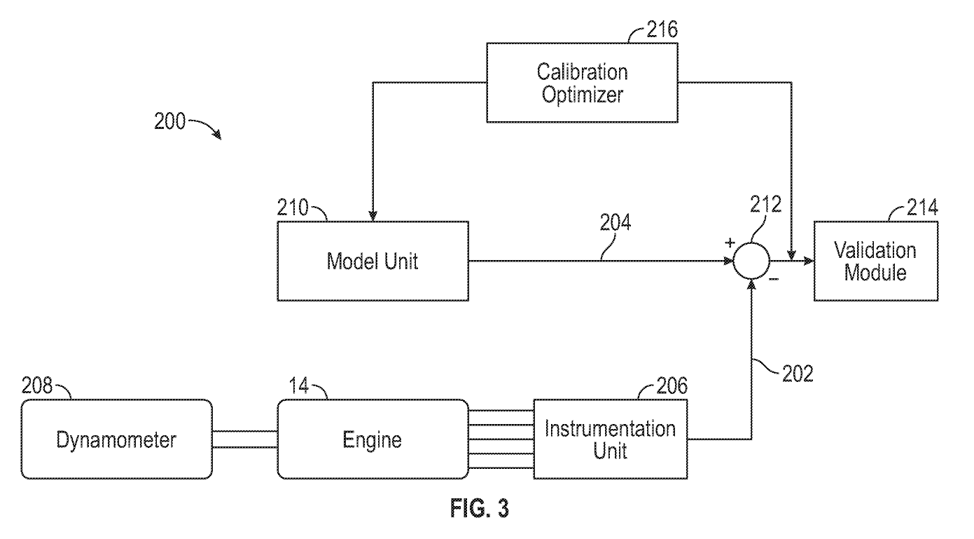

Referring to FIG. 3, an example method or control structure 200 is shown for adaptively fine-tuning the model parameters, by comparing measured parameters 202 and model-predicted parameters 204, such that the air path model may predict the actual engine responses more accurately. Referring to FIG. 3, the measured parameters 202 may be obtained from an Instrumentation Unit 206 receiving input from an engine 14. In one example, the engine 14 is operatively connected to a dynamometer 208. The model-predicted parameters 204 are obtained from a Model Unit 210, which may be a non-linear engine model or linearized LPV engine model stored in the controller C. In one embodiment, the model-predicted turbo speed, the compressor flow, the boost pressure and the intake manifold pressure (from the Model Unit 210) are compared with the actual measured turbo speed, the compressor flow, the boost pressure and the intake manifold pressure. The measured parameters 202 and the model-predicted parameters 204 are fed into a Summation Module 212 and their differences inputted into an online Validation Module 214. A Calibration Optimizer Module 216 includes an optimization routine, such as gradient search method, to fine tune some of the key model parameters and minimize the model prediction errors, and thus increase control system accuracy. Each of the modules, such as the Model Unit 210, Summation Module 212, Validation Module 214 and Calibration Optimizer 216, may be embedded as part of the controller C of FIG. 1.

The controller C of FIG. 1 may be an integral portion of, or a separate module operatively connected to, other controllers of the device 10, such as the engine controller. The controller C includes a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An engine assembly comprising:
an engine, an intake air throttle and a turbine operatively connected to one another, the turbine being operable at a turbine speed (Nₜ);
a compressor operatively connected to the engine;
a waste gate valve operatively connected to the turbine and configured to have a variable waste gate position (WGₚₒₛ);
a controller operatively connected to the turbine and the intake air throttle;
wherein the controller has a processor and a tangible, non-transitory memory on which is recorded instructions for executing a method of air path control based on an air path model, execution of the instructions by the processor causing the controller to:
determine a turbine power (Pₜ) of the turbine as a function of a first factor (x₁) and a second factor (x₂);
determine a compressor power (P_{c}) of the compressor as a function of a third factor (y₁) and a fourth factor (y₂);
control at least one of an intake throttle pressure (pₜₕ) and an intake manifold pressure (pᵢ) by varying at least one of the first, second, third and fourth factors (x₁, x₂, y₁, y₂); and
control an output of the engine based in part on at least one of the intake throttle pressure (pₜₕ) and the intake manifold pressure (pᵢ).

2. The assembly of claim 1, wherein determining the turbine power (Pₜ) includes:
determining a turbine power transfer rate (R̅_{c}) as at least one of a look-up factor and a polynomial function of the first factor (x₁), the second factor (x₂) and a plurality of constants (aᵢ) such that (Rₜ==a₀+a₁x₁+a₂x₂+a₃x₁²+a₄x₂²+a₅x₁·x₂+ . . . );
wherein the turbine power (Pₜ) is based in part on a turbine outlet pressure (pₜₒ), an exhaust temperature (Tₓ) and the turbine power transfer rate (R̅ₜ); and
wherein the first factor (x₁) and the second factor (x₂) are represented by a modified total exhaust flow
$$( {x}_{1} = \frac{{W}_{ex} \sqrt{{T}_{x}}}{{p}_{to}} )$$
and the waste gate position (x₂=WGₚₒₛ), respectively.

3. The assembly of claim 1, wherein determining the compressor power (P_{c}) includes:
determining a compressor power transfer rate (R_{c}) as at least one of a look-up factor and a polynomial function of the third factor (y₁), the fourth factor (y₂) and a plurality of constants (bᵢ) such that (R_{c}=b₀+b₁y₁+b₂y₂+b₃y₁²+b₄y₂²+b₅y₁·y₂+ . . . );
wherein the compressor power (P_{c}) is based in part on an enthalpy factor (h_{c}) and the compressor power transfer rate (R_{c}); and
wherein the third factor (y₁) and the fourth factor (y₂) are represented by the compressor pressure ratio (y₁=p_{rc}) and a modified compressor flow
$$( {y}_{2} = \frac{{W}_{C} \sqrt{{T}_{a}}}{{p}_{a}} ) ,$$
respectively.

4. The assembly of claim 1, wherein:
the intake throttle pressure (pₜₕ) is based in part on a compressor flow (W_{c}), a compressor outlet temperature (T_{co}), an intake air throttle flow (Wₜₕ), a charge-air-cooler outlet temperature (T_{CACO}) and a predefined constant
$$( \frac{γ R}{{V}_{cac}} ) .$$

5. The assembly of claim 1, wherein:
the intake manifold pressure (pᵢ) is based in part on an intake air throttle flow (Wₜₕ), a charge-air-cooler outlet temperature (T_{CACO}), a cylinder inlet flow (W_{cyl}), an engine speed (Nₑ), an intake manifold temperature (Tᵢₘ) and a predefined constant
$$( \frac{γ R}{{V}_{im}} ) .$$

6. The assembly of claim 1, wherein the controller is configured to:
determine one or more control parameters based in part on an energy balance relationship between the turbine power (Pₜ) the compressor power (P_{c}); and
wherein the intake throttle pressure (pₜₕ) and the intake manifold pressure (pᵢ) are based at least partially on the one or more control parameters.

7. The assembly of claim 6, wherein:
the one or more control parameters include the turbine speed (Nₜ) and a modified compressor flow
$$( \frac{{W}_{C} \sqrt{{T}_{a}}}{{p}_{a}} )$$
based on an ambient temperature (Tₐ) and an ambient pressure (pₐ); and
the energy-balance relationship is defined as
$$[ \frac{1}{2} J \frac{{dN}_{t}^{2}}{dt} = {kN}_{t}^{2} - {P}_{c} + {P}_{t} ] ,$$
where J is turbine inertia and k is a predefined constant.

8. The assembly of claim 6, wherein:
the one or more control parameters include the turbine speed (Nₜ), a compressor pressure ratio (p_{rc}) and a compressor flow rate (dW_{c}/dt);
the compressor flow rate (dW_{c}/dt) is based in part on the compressor outlet pressure (p_{co}), an intake manifold section area (Aᵢₘ) and an intake manifold length (Lᵢₘ) such that
$$[ \frac{{dW}_{C}}{dt} = \frac{{A}_{im}}{{L}_{im}} ( {p}_{co} - {p}_{th} ) ] ;$$
and
the energy-balance relationship is defined as
$$[ \frac{1}{2} J \frac{{dN}_{t}^{2}}{dt} = {kN}_{t}^{2} - {P}_{c} + {P}_{t} ] ,$$
where J is turbine inertia and k is a predefined constant.

9. The assembly of claim 6, wherein:
the one or more control parameters include the turbine speed (Nₜ), a turbine pressure ratio (pᵣₜ) and a turbine flow (Wₜ); and
the energy-balance relationship is defined as
$$[ \frac{1}{2} J \frac{{dN}_{t}^{2}}{dt} = {kN}_{t}^{2} - {P}_{c} + {P}_{t} ] ,$$
where J is turbine inertia and k is a predefined constant.

10. The assembly of claim 6, wherein:
the one or more control parameters include a modified exhaust flow
$$( \frac{{W}_{ex} \sqrt{{T}_{x}}}{{p}_{to}} ) ;$$
and
the energy-balance relationship is defined as
$$[ \frac{{dP}_{c}}{dt} = - {gP}_{c} + {P}_{t} ] ,$$
where g is a predefined constant.

11. A method of air path control in an engine assembly having an engine, a turbine, a compressor, an intake air throttle, a waste gate valve configured to have a variable waste gate position (WGₚₒₛ) and a controller having a processor and a tangible, non-transitory memory, the method comprising:
determining a turbine power (Pₜ) of the turbine as a function of a first factor (x₁) and a second factor (x₂), via the controller;
determining a compressor power (P_{c}) of the compressor as a function of a third factor (y₁) and a fourth factor (y₂);
controlling at least one of an intake throttle pressure (pₜₕ) and an intake manifold pressure (pᵢ) by varying at least one of the first, second, third and fourth factors (x₁, x₂, y₁, y₂); via respective command signals from the controller; and
controlling an output of the engine based in part on at least one of the intake throttle pressure (pₜₕ) and the intake manifold pressure (pᵢ), via the controller.

12. The method of claim 11, wherein determining the turbine power (Pₜ) includes:
determining a turbine power transfer rate (R̅ₜ) as at least one of a look-up factor and a polynomial function of the first factor (x₁), the second factor (x₂) and a plurality of constants (a) such that (Rₜ==a₀+a₁x₁+a₂x₂+a₃x₁²+a₄x₂²+a₅x₁·x₂+ . . . );
wherein the turbine power (Pₜ) is based in part on a turbine outlet pressure (pₜₒ), an exhaust temperature (Tₓ) and the turbine power transfer rate (R̅ₜ); and
wherein the first factor (x₁) and the second factor (x₂) are represented by a modified total exhaust flow
$$( {x}_{1} = \frac{{W}_{ex} \sqrt{{T}_{x}}}{{p}_{to}} )$$
and the waste gate position (x₂=WGₚₒₛ) respectively.

13. The method of claim 11, wherein determining the compressor power (P_{c}) includes:
determining a compressor power transfer rate (R_{c}) as at least one of a look-up factor and a polynomial function of the third factor (y₁), the fourth factor (y₂) and a plurality of constants (bᵢ) such that (R_{c}=b₀+b₁y₁+b₂y₂+b₃y₁²+b₄y₂²+b₅y₁·y₂+ . . . );
wherein the compressor power (P_{c}) is based in part on an enthalpy factor (h_{c}) and the compressor power transfer rate (R_{c}); and
wherein the third factor (y₁) and the fourth factor (y₂) are represented by the compressor pressure ratio (y₁=p_{rc}) and a modified compressor flow
$$( {y}_{2} - \frac{{W}_{C} \sqrt{{T}_{a}}}{{p}_{a}} ) ,$$
respectively.

14. The method of claim 11, wherein:
the intake throttle pressure (pₜₕ) is based in part on a compressor flow (W_{c}), a compressor outlet temperature (T_{co}), an intake air throttle flow (Wₜₕ), a charge-air-cooler outlet temperature (T_{CACO}) and a predefined constant
$$( \frac{γ R}{{V}_{cac}} ) .$$

15. The method of claim 11, wherein:
the intake manifold pressure (pᵢ) is based in part on an intake air throttle flow (Wₜₕ), a charge-air-cooler outlet temperature (T_{CACO}), a cylinder inlet flow (W_{cyl}), an engine speed (Nₑ), an intake manifold temperature (Tᵢₘ) and a predefined constant
$$( \frac{γ R}{{V}_{im}} ) .$$

16. The method of claim 11, further comprising:
determining one or more control parameters based in part on an energy balance relationship between the turbine power (Pₜ) the compressor power (P_{c}); and
wherein the intake throttle pressure (pₜₕ) and the intake manifold pressure (pᵢ) are based at least partially on the one or more control parameters.

17. The method of claim 16, wherein:
the one or more control parameters include the turbine speed (Nₜ) and a modified compressor flow
$$( \frac{{W}_{C} \sqrt{{T}_{a}}}{{p}_{a}} )$$
based on an ambient temperature (Tₐ) and an ambient pressure (pₐ); and
the energy-balance relationship is defined as
$$[ \frac{1}{2} J \frac{{dN}_{t}^{2}}{dt} = {kN}_{t}^{2} - {P}_{c} + {P}_{t} ] ,$$
where J is turbine inertia and k is a predefined constant.

18. The method of claim 16, wherein:
the one or more control parameters include the turbine speed (Nₜ), a compressor pressure ratio (p_{rc}) and a compressor flow rate (dW_{c}/dt);
the compressor flow rate (dW_{c}/dt) is based in part on the compressor outlet pressure (p_{co}), an intake manifold section area (Aᵢₘ) and an intake manifold length (Lᵢₘ) such that
$$[ \frac{{dW}_{C}}{dt} = \frac{{A}_{im}}{{L}_{im}} ( {p}_{co} - {p}_{th} ) ] ;$$
and
$$[ \frac{1}{2} J \frac{{dN}_{t}^{2}}{dt} = {kN}_{t}^{2} - {P}_{c} + {P}_{t} ] ,$$
the energy-balance relationship is defined as where J is turbine inertia and k is a predefined constant.

19. The method of claim 16, wherein:
the one or more control parameters include the turbine speed (Nₜ), a turbine pressure ratio (pᵣₜ) and an intake air throttle flow (Wₜₕ); and
the energy-balance relationship is defined as
$$[ \frac{1}{2} J \frac{{dN}_{t}^{2}}{dt} = {kN}_{t}^{2} - {P}_{c} + {P}_{t} ] ,$$
where J is turbine inertia and k is a predefined constant.

20. The method of claim 16, wherein:
the one or more control parameters include a modified exhaust flow
$$( \frac{{W}_{ex} \sqrt{{T}_{x}}}{{p}_{to}} ) ;$$
and
the energy-balance relationship is defined as
$$[ \frac{{dP}_{c}}{dt} = - {gP}_{c} + {P}_{t} ] ,$$
where g is a predefined constant.
